(19) United States
(12) Patent Application Publication
(10) Pub. No.: US 2019/0369614 A1
(43) Pub. Date: Dec. 5, 2019

(54) SYSTEM AND METHOD FOR CONTROLLING AN AUTONOMOUS VEHICLE

(71) Applicant: GM GLOBAL TECHNOLOGY OPERATIONS LLC, DETROIT, MI (US)

(72) Inventors: Jeffrey S. Parks, Ann Arbor, MI (US); Loren J. Majersik, Salt Lake City, UT (US); Chris C. Swoish, Lapeer, MI (US); Haley M. Dalzell, Troy, MI (US)

(21) Appl. No.: 15/994,177

(22) Filed: May 31, 2018

(51) Int. Cl. G05D 1/00

(52) U.S. Cl. CPC G05D 1/0061; G05D 2201/0213; G05D 1/0088

(57) ABSTRACT

An automotive vehicle includes at least one actuator configured to control vehicle steering, at least one sensor configured to detect a location of a lane boundary proximate the vehicle, and a controller. The controller is configured to control the at least one actuator according to an autonomous driving mode. The controller is also configured to determine a width of a lane occupied by the vehicle based on a sensor reading from the at least one sensor, and, in response to the determined lane width being below a predefined with threshold, discontinue autonomous control of the at least one actuator.

### TECHNICAL FIELD

The present disclosure relates to vehicles controlled by automated driving systems, particularly those configured to automatically control vehicle steering, acceleration, and braking during a drive cycle without human intervention.

### INTRODUCTION

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes at least one actuator configured to control vehicle steering, at least one sensor configured to detect a location of a lane boundary proximate the vehicle, and a controller. The controller is configured to control the at least one actuator according to an autonomous driving mode. The controller is also configured to determine a width of a lane occupied by the vehicle based on a sensor reading from the at least one sensor, and, in response to the determined lane width being below a predefined with threshold, discontinue autonomous control of the at least one actuator.

In an exemplary embodiment, the at least one sensor comprises an optical camera.

In an exemplary embodiment, the controller is further configured to calculate a confidence parameter associated with the determined lane width, and the controller is configured to discontinue autonomous control in further response to the confidence parameter exceeding a predefined confidence threshold. In such embodiments, the confidence parameter may be calculated based on a first signal from a first sensor and a second signal from a second sensor. The confidence parameter may also calculated based on a first offset between a vehicle centerline and a driver-side lane marking and a second offset between a vehicle centerline and a passenger-side lane marking. The confidence parameter may include a first confidence increment and a second confidence increment, with the first confidence increment being based on an instantaneous lane width calculation and the second confidence increment being based on a change in calculated lane width over time.

A method of controlling a vehicle according to the present disclosure includes providing a vehicle with at least one actuator configured to control vehicle steering, at least one sensor configured to detect a location of a lane boundary proximate the vehicle, and a controller configured to automatically control the at least one actuator in an autonomous driving mode. The method additionally includes receiving at least one signal via the at least one sensor. The method also includes calculating, via the controller, a lane width of a current driving lane of the vehicle based on the at least one signal. The method further includes, in response to the lane width being below a threshold, automatically discontinuing, via the controller, the autonomous driving mode.

In an exemplary embodiment, the method additionally includes calculating, via the controller, a confidence parameter associated with the lane width. In such embodiments, the automatically discontinuing of the autonomous driving mode is in further response to the confidence parameter exceeding a predefined confidence threshold. In such embodiments, the at least one sensor may include a first sensor and a second sensor, and receiving at least one signal includes receiving a first signal from the first sensor and a second signal from the second sensor. In such an embodiment, the confidence parameter comprises a first confidence increment and a second confidence increment, with the first confidence increment being based on the first signal and the second confidence increment being based on the second signal. The confidence parameter may include a first confidence increment and a second confidence increment, with the first confidence increment being based on an instantaneous lane width calculation and the second confidence increment being based on a change in calculated lane width over time.

In an exemplary embodiment, the at least one sensor comprises an optical camera.

Embodiments according to the present disclosure provide a number of advantages. For example, the present disclosure provides a system and method for determining whether a current driving lane width is below a threshold, and for taking corrective action when such a determination is made.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a flowchart representation of a method of controlling a vehicle according to an embodiment of the present disclosure;

FIG. 4 is a schematic representation of an algorithm for controlling a vehicle according to an embodiment of the present disclosure; and

FIG. 5 is an illustration of a vehicle in a driving lane according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

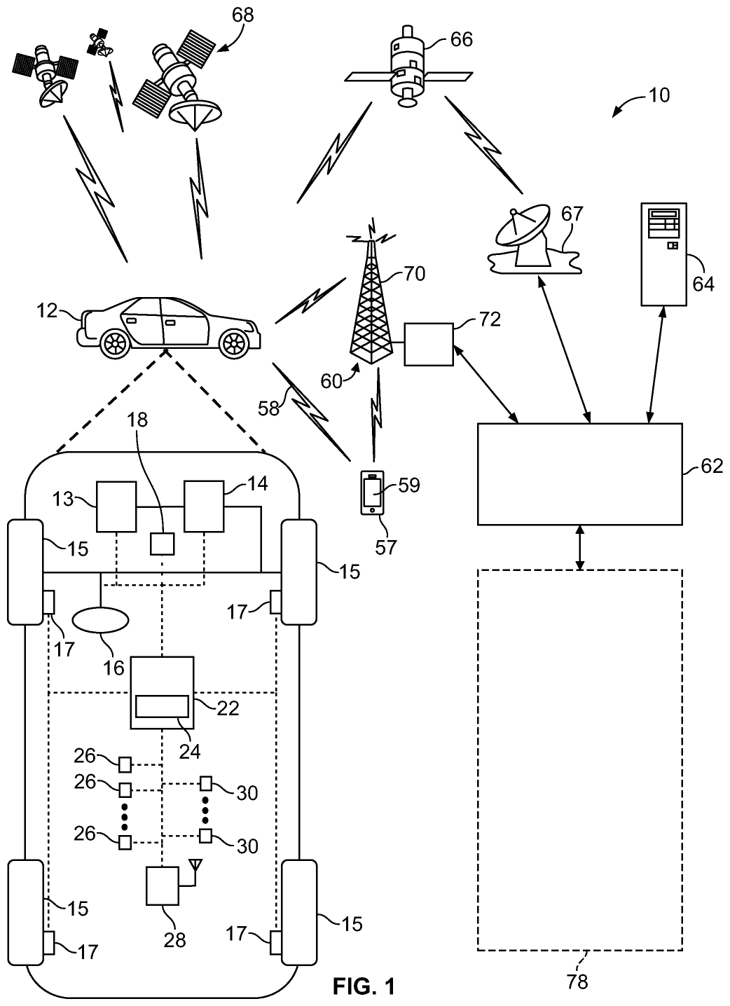

FIG. 1 schematically illustrates an operating environment that comprises a mobile vehicle communication and control system 10 for a motor vehicle 12. The communication and control system 10 for the vehicle 12 generally includes one or more wireless carrier systems 60, a land communications network 62, a computer 64, a mobile device 57 such as a smart phone, and a remote access center 78.

The vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The vehicle 12 includes a propulsion system 13, which may in various embodiments include an internal combustion engine, an electric machine such as a traction motor, and/or a fuel cell propulsion system.

The vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The vehicle 12 additionally includes a steering system 16. While depicted as including a steering wheel for illustrative purposes, in some embodiments contemplated within the scope of the present disclosure, the steering system 16 may not include a steering wheel.

The vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Three automation system. A Level Three system indicates “Conditional Automation”, referring to the driving mode-specific performance by an automated driving system of all aspects of the dynamic driving task with the expectation that the human driver will respond appropriately to a request to intervene.

Other embodiments according to the present disclosure may be implemented in conjunction with so-called Level One or Level Two automation systems. A Level One system indicates “driver assistance”, referring to the driving mode-specific execution by a driver assistance system of either steering or acceleration using information about the driving environment and with the expectation that the human driver perform all remaining aspects of the dynamic driving task. A Level Two system indicates “Partial Automation”, referring to the driving mode-specific execution by one or more driver assistance systems of both steering and acceleration using information about the driving environment and with the expectation that the human driver perform all remaining aspects of the dynamic driving task.

Still other embodiments according to the present disclosure may also be implemented in conjunction with so-called Level Four or Level Five automation systems. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the vehicle 12. One of the networked devices that can communicate with the vehicle 12 via the wireless communication system 28 is the mobile device 57. The mobile device 57 can include computer processing capability, a transceiver capable of communicating using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving GPS satellite signals and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the vehicle 12. The computer 64 may be in communication with at least one supplemental vehicle in addition to the vehicle 12. The vehicle 12 and any supplemental vehicles may be collectively referred to as a fleet.

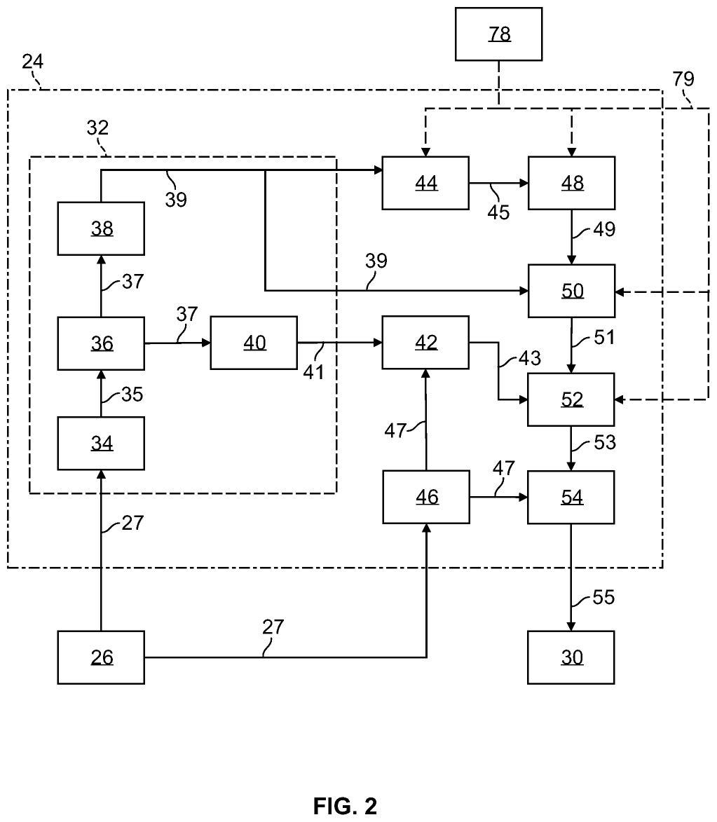

As shown in FIG. 2, the ADS 24 includes multiple distinct control systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation model 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the vehicle 12 during operation and mapping data “pushed” to the vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

Under some driving conditions, it may be desirable for the ADS 24 to control the vehicle 12 according to an alternate driving mode. One such driving condition arises when the vehicle 12 is positioned in a relatively narrow lane, or when the available driving path is otherwise narrowed.

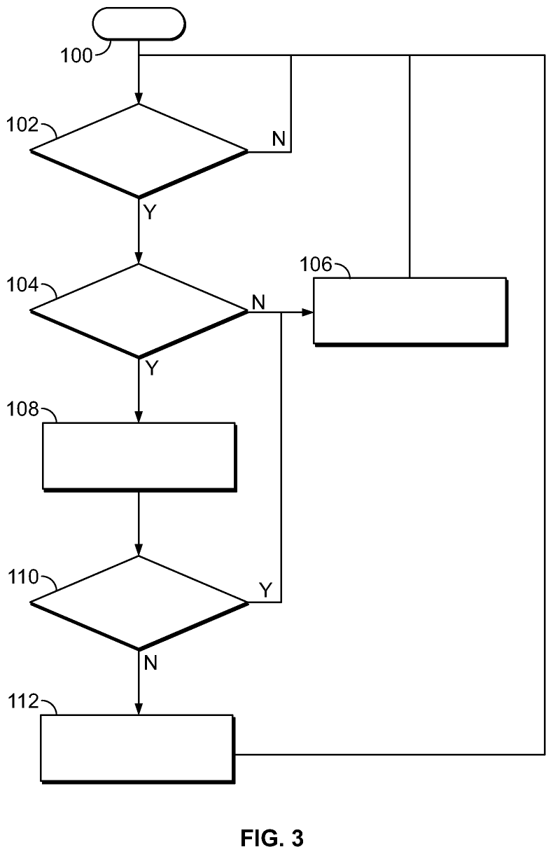

Referring now to FIG. 3, a method of controlling a vehicle according to the present disclosure is illustrated in flowchart form. The algorithm begins at block 100, e.g. at the beginning of a drive cycle.

A determination is made of whether a lanekeeping mode is active, as illustrated at operation 102. The lanekeeping mode refers to ADS control of the steering system. In various embodiments the lanekeeping mode may be activated in response to various inputs, e.g. in response to a user activation of an autonomous mode, or as a default control mode at the beginning of a drive cycle.

In response to the determination of operation 102 being negative, i.e. the lanekeeping mode not being active, control returns to operation 102. In the illustrated embodiment, the algorithm therefore does not proceed unless and until the lanekeeping mode is activated. However, it should be noted that in alternate embodiments, the algorithm may run continuously and be configured to, e.g., inhibit activation of the lanekeeping mode in response to the lane width being below a predefined threshold.

In response to the determination of operation 102 being positive, then a determination is made of whether a sensor fidelity criterion is satisfied. The sensor fidelity criterion may be associated with one or more sensor, e.g. the sensor 26. In various embodiments, the sensor fidelity criterion comprises a determination that signal quality exceeds a threshold, a determination that sensor data has been recently refreshed, a determination that sensor lenses are adequately clear, other criterion, or any combination thereof.

In response to the determination of operation 104 being negative, i.e. the sensor fidelity criterion not being satisfied, then a secondary control mode is executed, as illustrated at block 106. In various embodiments, the secondary control mode comprises deactivating the lanekeeping mode and returning steering control to a human operator, communicating an alert to a human operator, communicating a help request to a remote assistance center, other secondary control mode, or any combination thereof. Control then returns to operation 102.

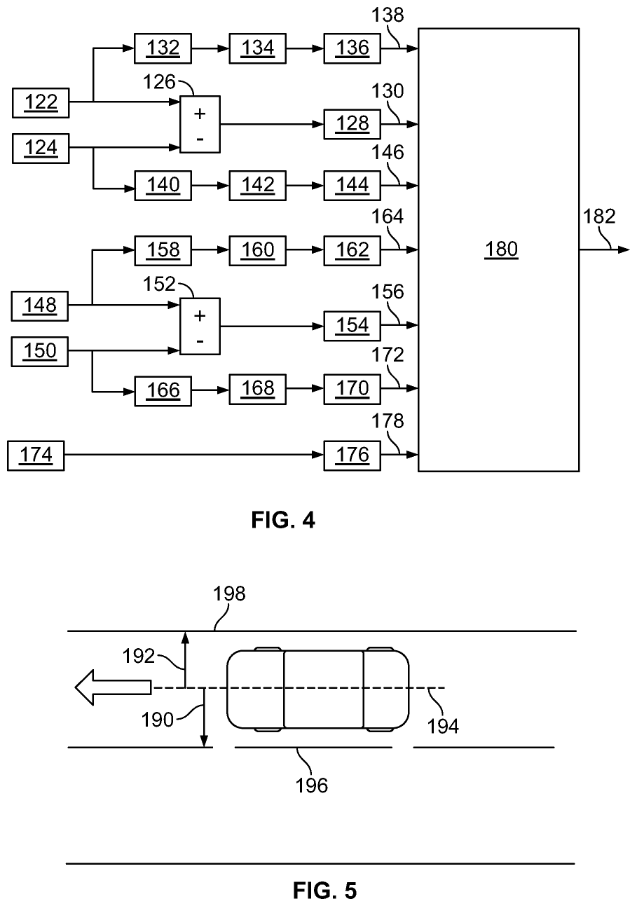

In response to the determination of operation 104 being positive, then a narrow lane confidence factor is calculated, as illustrated at block 108. A narrow lane confidence factor refers to a confidence or likelihood that the width of a current driving lane is below a predefined width threshold. In an exemplary embodiment, the width threshold is defined based on a track width of the vehicle, e.g. as 150% of the track width of the vehicle. An exemplary method for calculating the confidence factor will be discussed below with respect to FIGS. 4 and 5.

A determination is made of whether the narrow lane confidence factor exceeds a confidence threshold, as illustrated at operation 110. The confidence threshold may be, for example, 75%.

In response to the determination of operation 110 being positive, i.e. the confidence factor exceeds the confidence threshold, then the secondary mode is executed, as illustrated at block 106 and discussed above.

In response to the determination of operation 110 being negative, the lanekeeping mode is executed as illustrated at block 112. The steering system is thereby automatically controlled to maintain a desired vehicle lane. Control then returns to operation 102.

Referring now to FIG. 4, a logic diagram for calculating lane width is illustrated schematically. The logic described herein may be performed by a controller, e.g. the controller 22, based on instructions and data stored in non-transient data memory.

A first driver-side offset 122 and a first passenger-side offset 124 are obtained. As illustrated in FIG. 5, a driver-side offset 190 refers to a lateral distance between a longitudinal center 194 of the vehicle and a driver-side lane marking 196, and a passenger-side offset 192 refers to a lateral distance between the longitudinal center 194 and a passenger-side lane marking 198. The offsets 122, 124 may be calculated based on signals from one or more of the sensors 26. In an exemplary embodiment, the offsets 122, 124 are calculated based on signals from a first optical camera, e.g. a forward-looking optical camera.

A difference between the offsets 122, 124 is calculated at block 126 to obtain an instantaneous measurement of lane width, and the resulting instantaneous lane width is input to a first calibration table 128. For a given instantaneous lane width, the first calibration table 128 includes a corresponding confidence metric indicating a confidence or likelihood that the width is the current driving lane is narrow, e.g. below a predefined width threshold. The first calibration table 128 outputs a first confidence metric 130 based on the instantaneous lane width. In an exemplary embodiment, the first confidence metric is provided as an incremental value, e.g. having a positive value indicating high confidence when the difference indicates that the current driving lane is narrow, and a negative value indicating low confidence when the difference indicates that the driving lane is wide.

A first delta 132 is calculated between the first driver-side offset 122 and a previously-calculated value of the first driver-side offset 122. The first delta 132 therefore represents a change in the driver-side offset between subsequent measurements. An absolute value of the first delta 132 is obtained at block 134, and the result is input to a second calibration table 136, which may be configured generally similarly to the first calibration table 128. The second calibration table 136 outputs a second confidence metric 138. The second confidence metric 138 indicates a confidence or likelihood that the current driving lane is below the threshold, and may be provided as an incrementor as discussed above with respect to the first confidence metric 130.

A second delta 140 is calculated between the first passenger-side offset 124 and a previously-calculated value of the first passenger-side offset 124. The second delta 140 therefore represents a change in the passenger-side offset between subsequent measurements. An absolute value of the second delta 140 is obtained at block 142, and the result is input to a third calibration table 144, which may be configured generally similarly to the first calibration table 128. The third calibration table 144 outputs a third confidence metric 146. The third confidence metric 146 indicates a confidence or likelihood that the current driving lane is narrow, and may be provided as an incrementor as discussed above with respect to the first confidence metric 130.

A second driver-side offset 148 and a second passenger-side offset 150 are also obtained. The offsets 148, 150 may be calculated based on signals from one or more of the sensors 26. In an exemplary embodiment, the offsets 148, 150 are calculated based on signals from sensors distinct from those used for the offsets 122, 124, such as a second optical camera, e.g. a short-range peripheral optical camera.

A difference between the offsets 148, 150 is calculated at block 152 to obtain a lane width, and the difference is input to a fourth calibration table 154, which may be configured generally similarly to the first calibration table 128. The fourth calibration table 154 outputs a fourth confidence metric 156 based on the difference. The fourth confidence metric 156 indicates a confidence or likelihood that the current driving lane is narrow, and may be provided as an incrementor as discussed above with respect to the first confidence metric 130.

A third delta 158 is calculated between the second driver-side offset 148 and a previously-calculated value of the second driver-side offset 148. The third delta 158 therefore represents a change in the driver-side offset between subsequent measurements. A large change may indicate that the lane width has changed or is otherwise unstable. An absolute value of the third delta 158 is obtained at block 160, and the result is input to a fifth calibration table 162, which may be configured generally similarly to the first calibration table 128. The fifth calibration table 162 outputs a fifth confidence metric 164. The fifth confidence metric 164 indicates a confidence or likelihood that the current driving lane is narrow, and may be provided as an incrementor as discussed above with respect to the first confidence metric 130.

A fourth delta 166 is calculated between the second passenger-side offset 150 and a previously-calculated value of the second passenger-side offset 150. The fourth delta 166 therefore represents a change in the passenger-side offset between subsequent measurements. An absolute value of the fourth delta 166 is obtained at block 168, and the result is input to a sixth calibration table 170, which may be configured generally similarly to the first calibration table 128. The sixth calibration table 170 outputs a sixth confidence metric 172. The sixth confidence metric 172 indicates a confidence or likelihood that the current driving lane is narrow, and may be provided as an incrementor as discussed above with respect to the first confidence metric 130.

A filtered lane width value 174 is obtained, e.g. from a localization and mapping module as discussed above in conjunction with FIG. 2. The filtered lane width value 174 may be calculated as a byproduct of a lane-centering calculation, e.g. by the path planning module 50. The filtered lane width value 174 is input to a seventh calibration table 176, which may be configured generally similarly to the first calibration table 128. The seventh calibration table 176 outputs a seventh confidence metric 178. The seventh confidence metric 178 indicates a confidence or likelihood that the current driving lane is narrow, and may be provided as an incrementor as discussed above with respect to the first confidence metric 130.

The first confidence metric 130, second confidence metric 138, third confidence metric 146, fourth confidence metric 156, fifth confidence metric 164, sixth confidence metric 172, and seventh confidence metric 178 are all input to an accumulator 180. The accumulator 180 is configured to aggregate the confidence metrics 130, 138, 146, 156, 164, 172, and 178 across a plurality of cycles and output an accumulated confidence 182. The accumulated confidence 182 indicates an overall confidence or likelihood that the current driving lane is below the threshold. Because each of the confidence metrics 130, 138, 146, 156, 164, 172, and 178 may be positive or negative increments, the accumulated confidence 182 may likewise rise and fall based on current conditions. Moreover, the accumulator 180 provides a hysteresis effect such that transient changes in lane width measurements may be disregarded. In response to the accumulated confidence 182 exceeds a predefined threshold, a determination may be made that the current driving lane width is narrow, as discussed above with respect to step 110 in FIG. 3.

As may be seen the present disclosure provides a system and method for determining whether a current driving lane width is below a threshold, and for taking corrective action when such a determination is made.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one actuator configured to control vehicle steering;
at least one sensor configured to detect a location of a lane boundary proximate the vehicle; and
a controller configured to control the at least one actuator according to an autonomous driving mode, the controller being configured to determine a width of a lane occupied by the vehicle based on a sensor reading from the at least one sensor, and, in response to the determined lane width being below a predefined with threshold, discontinue autonomous control of the at least one actuator.

2. The vehicle of claim 1, wherein the at least one sensor comprises an optical camera.

3. The vehicle of claim 1, wherein the controller is further configured to calculate a confidence parameter associated with the determined lane width, and wherein the controller is configured to discontinue autonomous control in further response to the confidence parameter exceeding a predefined confidence threshold.

4. The vehicle of claim 3, wherein the confidence parameter is calculated based on a first signal from a first sensor and a second signal from a second sensor.

5. The vehicle of claim 3, wherein the confidence parameter is calculated based on a first offset between a vehicle centerline and a driver-side lane marking and a second offset between a vehicle centerline and a passenger-side lane marking.

6. The vehicle of claim 3, wherein the confidence parameter comprises a first confidence increment and a second confidence increment, the first confidence increment being based on an instantaneous lane width calculation, the second confidence increment being based on a change in calculated lane width over time.

7. A method of controlling a vehicle comprising:
providing a vehicle with at least one actuator configured to control vehicle steering, at least one sensor configured to detect a location of a lane boundary proximate the vehicle, and a controller configured to automatically control the at least one actuator in an autonomous driving mode;
receiving at least one signal via the at least one sensor;
calculating, via the controller, a lane width of a current driving lane of the vehicle based on the at least one signal; and
in response to the lane width being below a threshold, automatically discontinuing, via the controller, the autonomous driving mode.

8. The method of claim 7, further comprising calculating, via the controller, a confidence parameter associated with the lane width, wherein the automatically discontinuing the autonomous driving mode is in further response to the confidence parameter exceeding a predefined confidence threshold.

9. The method of claim 8, wherein the at least one sensor comprises a first sensor and a second sensor, wherein receiving at least one signal comprises receiving a first signal from the first sensor and a second signal from the second sensor, and wherein the confidence parameter comprises a first confidence increment and a second confidence increment, the first confidence increment being based on the first signal, the second confidence increment being based on the second signal.

10. The method of claim 8, wherein the confidence parameter comprises a first confidence increment and a second confidence increment, the first confidence increment being based on an instantaneous lane width calculation, the second confidence increment being based on a change in calculated lane width over time.

11. The method of claim 7, wherein the at least one sensor comprises an optical camera.
